(19) United States
(12) Patent Application Publication
(10) Pub. No.: US 2024/0043977 A1
(43) Pub. Date: Feb. 8, 2024

(54) HIGH INTERFACIAL BONDING STRENGTH LAMINATED ALUMINUM ALLOY MANUFACTURING METHOD

(71) Applicant: JIMEI UNIVERSITY, Xiamen (CN)

(72) Inventors: Wenhui LIU, Xiamen (CN); Xiaoming YUE, Xiamen (CN); Changping TANG, Xiamen (CN); Xiao LIU, Xiamen (CN); Xuefeng DING, Xiamen (CN); Yufeng SONG, Xiamen (CN); Jianguo TANG, Xiamen (CN); Shanming LUO, Xiamen (CN); Hao HUANG, Xiamen (CN)

(73) Assignee: JIMEI UNIVERSITY, Xiamen (CN)

(21) Appl. No.: 18/096,064

(22) Filed: Jan. 12, 2023

(30) Foreign Application Priority Data
Aug. 2, 2022 (CN) 202210921961.0

(51) Int. Cl. C22F 1/04; B23K 20/12; B23K 20/24; B32B 15/01; B21B 1/38

(52) U.S. Cl. CPC C22F 1/04; B23K 20/122; B23K 20/24; B32B 15/016; B21B 1/38; B23K 2103/10

(57) ABSTRACT

A high interfacial bonding strength laminated aluminum alloy manufacturing method includes: combining and fixing a rear plate, a middle plate, and a front plate to obtain a combined plate; performing a first heat treatment on the combined plate and then performing a first roll-bonding to obtain a laminated aluminum alloy; conducting a friction stir treatment after setting a weld-start plate and a lead-out plate on the laminated aluminum alloy; and carrying out a second heat treatment, a second rolling treatment, a solid solution treatment and an aging treatment in sequence on the laminated aluminum alloy after the friction stir treatment. By friction stir treatment of the laminated aluminum alloy, the original interlayer structure is broken and a three-dimensional spatial structure consisting of the nugget zone and an interlocked structural zone is formed. As a result, the interlayer bonding strength of the laminated aluminum alloy is greatly improved.

### CROSS REFERENCE TO THE RELATED APPLICATIONS

This application claims priority based on Chinese patent application No. 202210921961.0 filed on Aug. 2, 2022, the entire contents of which are hereby incorporated by reference.

### TECHNICAL FIELD

The present invention relates to the technical field of manufacturing and processing of metal composites, and in particular to a high interfacial bonding strength laminated aluminum alloy manufacturing method.

### BACKGROUND

With the development of modern warfare, armored vehicles will be subjected to more lethal attacks on all fronts in future combat, putting forward new and higher requirements for armor material defense and survivability. Armored vehicle defense materials require good processing performance, light weight, good impact resistance, excellent welding performance, good corrosion resistance and other advantages. Homogeneous armors are difficult to be effective for all kinds of anti-armor weapons. Although increasing the thickness of homogeneous armor can improve its defense ability, it will also increase the mass of armored vehicles and reduce their flexibility. In order to further improve the ballistic performance of armored vehicles while protecting against different anti-armor weapons, the use of materials with different properties to make composite armor materials has become the main direction of armor material development. Composite armor performance with designability can be designed according to the combat environment and the use of different parts of a series of different performance, different mass and thickness of the armor, such as: research shows that the material with reinforcement structure of the ballistic performance is much higher than the ballistic performance without reinforcement structure. Nowadays, the laminated composite armor includes multi-layer aluminum alloy armor, titanium/aluminum multi-layer composite armor, steel/aluminum composite armor, etc. Although the laminated composite armor has a series of advantages, there are disadvantages such as complicated manufacturing technology, high cost, poor bonding between layers, easy to crack, etc. Moreover, the interface of the laminated aluminum alloy prepared by the traditional method is flat, and the improvement of the bonding strength between the interfaces of the components is greatly limited, and the cracking between layers is easy to occur.

Therefore, it is of great importance and practical value to develop a method for manufacturing a stacked aluminum alloy that is easy to operate, has strong interlayer bonding.

### SUMMARY

The purpose of the present invention is to provide a high interfacial bonding strength laminated aluminum alloy manufacturing method to solve the technical problem of poor interlayer bonding and easy delamination cracking of laminated aluminum alloys in the prior art.

In order to achieve the purpose of the present invention, the present invention provides the following technical scheme:

The present invention provides a high interfacial bonding strength laminated aluminum alloy manufacturing method, comprising the following steps:
Step (1): combining and fixing a rear plate, a middle plate, and a front plate to obtain a combined plate.
Step (2): performing heat treatment on the combined plate and then performing a first roll-bonding to obtain a laminated aluminum alloy;
Step (3): conducting friction stir treatment after setting the weld-start plate and lead-out plates on the laminated aluminum alloy;
Step (4): carrying out heat treatment, second rolling treatment, solid solution treatment and aging treatment in sequence on the laminated aluminum alloy after friction stir treatment;

In the friction stir treatment in said step (3), the stirring needle is provided with a thread, the length of the stirring needle h=hᵣₑₐᵣ+h_{middle}+(0.1−10) mm, wherein, hᵣₑₐᵣ and h_{middle} are the thickness of the rear plate and the middle plate after roll-bonding in step (2), respectively; during friction stir treatment, the stirring tool rotates into the laminated aluminum alloy from the rear plate side, and the back tilt angle of the stirring tool is 1-3°; and the feed speed is 50-250 mm/min and the rotation speed is 400-2,500 r/min.

Further, said step (1) in which the rear plate comprises 7N01 aluminum alloy or 7A52 aluminum alloy; said middle plate comprises 1-series pure aluminum alloy or 7A01 aluminum alloy; and said front plate comprises 7055 aluminum alloy or 7A62 aluminum alloy.

Further, said step (1) firstly, the rear plate, middle plate and front plate are surface treated and then combined, said surface treatment steps are: alkaline washing with 5-15 wt % NaOH solution for 3-10 min and then rinsing with 80-100° C. water, then acid washing with 5-15 wt % HNO₃ solution for 3-10 min and then rinsing with 5-15° C. water, and finally blowing dry, interface sanding treatment in sequence.

Further, said step (2) in the heat treatment temperature of 400-450° C., the heat treatment time of 1 to 3 h.

Further, the thickness of the laminated aluminum alloy in step (2) is 3-60 mm.

Further, the temperature of heat treatment in said step (4) is 370-420° C. and the time of heat treatment is 1 to 2 h.

Further, the temperature of the solid solution treatment in said step (4) is 450-490° C., and the time of the solution treatment is 1 to 3 h.

Further, the temperature of aging treatment in said step (4) is 100-150° C., and the time of aging treatment is 12 to 48 h.

### Beneficial Effect of the Present Invention

The present invention frictionally treats the laminated aluminum alloy by friction stir processing, and the interlayer structure in the stirred area is broken, and a three-dimensional spatial structure consisting of the nugget zone and an interlocked structural zone is formed. Since the strength of materials in the interlocked zone and the nugget zone is much higher than that of the bonding interface, therefore, the interfacial bonding strength of the laminated aluminum alloy is greatly improved.

The present invention has less welding defects, the weld microstructure is strengthened in subsequent rolling, solid solution and aging treatments, so that the overall strength of the laminated aluminum alloy can be effectively maintained.

The manufacturing method provided in the present invention is easy to operate and can be industrialized.

The manufacturing method provided by the present invention can be used for single-layer metallic materials and laminated metallic composites to prevent delamination cracking of thick metallic plates or laminated metallic composites.

### BRIEF DESCRIPTION OF THE DRAWINGS

FIG. 1 shows a schematic diagram of a high interfacial bonding strength laminated aluminum alloy manufacturing method of the present invention, wherein: 1. Rear plate, 2. middle plate, 3. Front plate, 4. weld seam, 5. weld-start plate, 6. stirring tool, 7. lead-out plate, 8. rivet;

FIG. 2 shows a microstructure of the laminated aluminum alloy prepared in Embodiment 1;

FIG. 3 shows a local microstructure diagram of the laminated aluminum alloy prepared in Embodiment 1;

FIG. 4 shows a microstructure diagram of the laminated aluminum alloy prepared in Contrast 1.

### DETAILED DESCRIPTION OF THE EMBODIMENTS

The present invention provides a high interfacial bonding strength laminated aluminum alloy manufacturing method, comprising the following steps:
Step (1): Combine the rear plate, middle plate, and front plate and fix them to obtain a combined plate.
Step (2): Apply heat treating to the combined plate and then performing the first roll-bonding to obtain the laminated aluminum alloy;
Step (3): Conduct friction stir treatment after setting the weld-start plate and lead-out plates on the laminated aluminum alloy;
Step (4): Perform heat treatment, second rolling treatment, solid solution treatment and aging treatment sequentially on the friction stir treated laminated aluminum alloy.

In the present invention, the rear plate in said step (1) includes 7N01 aluminum alloy or 7A52 aluminum alloy, preferably 7N01 aluminum alloy; said middle plate includes 1-series pure aluminum or 7A01 aluminum alloy, preferably 1-series pure aluminum; said front plate includes 7055 aluminum alloy or 7A62 aluminum alloy, preferably 7055 aluminum alloy.

According to the present invention, preferably the rear plate, middle plate and front plate in the said step (1) are combined after surface treatment, and the said surface treatment steps include: alkaline wash with 5-15 wt % NaOH solution for 3-10 min and then rinse with 80-100° C. water, then acid wash with 5-15 wt % HNO₃ solution for 3-10 min and then rinse with 5-15° C. water, and finally blow dry in turn, the Interface polishing treatment; preferably with 10 wt % of NaOH solution alkaline wash 5 min after rinsing with 80° C. water, then with 10 wt % of HNO₃ solution acid wash 5 min after rinsing with 10° C. water, and finally blow dry, interface polishing treatment in turn.

In the present invention, said fixing is preferably to drill holes at the front and rear ends of the combined plate and fix it by riveting with aluminum alloy rivets.

In the present invention, the temperature of heat treatment in said step (2) is 400-450° C., preferably 410-440° C., further preferably 420-430° C.; the time of heat treatment is 1-3 h, preferably 1.5-2.5 h, further preferably 2 h.

In the present invention, in the friction stir treatment in said step (3), the stirring needle is provided with a thread, the length of the stirring needle h=hᵣₑₐᵣ+h_{middle}+(0.1−10) mm, wherein, hᵣₑₐᵣ and h_{middle} are the thickness of the rear plate and the middle plate after roll-bonding in step (2), respectively; during friction stir treatment, the stirring tool rotates into the laminated aluminum alloy from the rear plate side, and the back tilt angle of the stirring tool is 1-3°, preferably 2°; and the feed speed is 50-250 mm/min, preferably 100-160 mm/min and the rotation speed is 400-2,500 r/min, preferably 1,600-2,000 r/min, further preferably 1,800 r/min.

In the present invention, the temperature of heat treatment in said step (4) is 370-420° C., preferably 380-410° C., further preferably 390-400° C.; the time of heat treatment is 1-2 h, preferably 1.5 h.

In the present invention, the temperature of the solid solution treatment in said step (4) is 450-490° C., preferably 460-480° C., further preferably 470° C.; the time of the solution treatment is 1-3 h, preferably 1.5-2.5 h, further preferably 2 h.

In the present invention, the temperature of aging treatment in said step (4) is 100-150° C., preferably 110-140° C., further preferably 120° C.; the time of aging treatment is 12-48 h, preferably 16-40 h, further preferably 20 to 36 h.

In the following, the technical scheme provided by the present invention will be described in detail with reference to the embodiments, but they should not be construed as limiting the scope of the present invention.

### Embodiment 1

Firstly, the 7A52 aluminum alloy rear plate with thickness of 9 mm, the 7A01 aluminum alloy middle plate with thickness of 1 mm, and the 7A62 aluminum alloy front plate with thickness of 26 mm are subjected to surface treatment: alkaline wash with 10 wt % NaOH solution for 5 min and then rinse with 80° C. water, then acid wash with 10 wt % HNO₃ solution for 5 min and then rinse with 10° C. water, and finally blow dry with hot air and use steel wire brush to polish, then combine the rear plate, middle plate and front plate, drill holes in the front and rear ends of the combined plate, and fix them with aluminum rivets to obtain the combined plate;

Conduct the first rolling compound after heat treatment of the combined plate for 2 h at 420° C., and the thickness of the laminated aluminum alloy obtained is 10 mm, wherein hᵣₑₐᵣ+h_{middle} is about 2.8 mm;

Set the 10 mm thick aluminum alloy weld-start plate and lead-out plate on the laminated aluminum alloy of thickness 10 mm, and then carrying out friction stir treatment, wherein the stirring needle is provided with a thread, the length of the stirring needle is 3.5 mm, the stirring needle rotates in from the side of the 7A52 aluminum alloy rear plate, the back tile angle of the stirring tool is 1.5°, the feed speed is 100 mm/min and the stirring rotation speed is 1,750 r/min during the friction stir treatment;

After the stirring treatment, the laminated aluminum alloy is heat-treated at 380° C. for 1.5 h and then rolled for the second time to obtain the laminated aluminum alloy with thickness of 8 mm, and then the laminated aluminum alloy is solid solution treated at 470° C. for 2 h and aged at 120° C. for 24 h to obtain the laminated aluminum alloy with high interfacial bond strength.

### Embodiment 2

Firstly, 7A52 aluminum alloy rear plate with thickness of 17 mm, 7A01 middle plate with thickness of 1 mm, and 7A62 aluminum alloy front plate with thickness of 17 mm were subjected to surface treatment: alkaline washing with 5 wt % NaOH solution for 10 min and then rinsing with 100° C. water, then acid washing with 15 wt % HNO₃ solution for 3 min and then rinsing with 15° C. water, finally blowing dry with hot air and polishing the interface with a wire brush and then the rear plate, middle plate and front plate are combined, and holes are drilled at the front and rear ends of the combined plate and fixed by riveting with aluminum alloy to obtain the combined plate;

Conduct the first rolling compound after heat treatment of the combined plate for 3 h at 410° C., and obtaining the laminated aluminum alloy with a thickness of 15 mm, wherein the hᵣₑₐᵣ+h_{middle} is about 7.7 mm;

Set the 15 mm aluminum alloy weld-start plate and the lead-out plate on the laminated aluminum alloy with the thickness of 15 mm, and then carrying out the friction stir treatment, wherein the stirring needle is provided with a thread, the length of the stirring needle is 8.5 mm, the stirring tool rotates in from the side of the 7A52 aluminum alloy rear plate, the back tilt angle of the stirring tool is 1°, the feed speed during the friction stir treatment is 150 mm/min and the stirring rotation speed is 1,500 r/min;

After the stirring treatment, the laminated aluminum alloy is heat-treated at 390° C. for 1 h and then rolled for the second time to obtain the laminated aluminum alloy with thickness of 6 mm, and then the laminated aluminum alloy is solid solution treated at 460° C. for 3 h and aged at 110° C. for 12 h to obtain the laminated aluminum alloy with high interfacial bond strength.

### Embodiment 3

Firstly, 7N01 aluminum alloy rear plate with thickness of 15 mm, pure aluminum middle plate with thickness of 1 mm, and 7055 aluminum alloy front plate with thickness of 20 mm were subjected to surface treatment: alkaline washing with 15 wt % NaOH solution for 3 min and then rinsing with water at 90° C., then acid washing with 5 wt % HNO₃ solution for 10 min and then rinsing with water at 5° C., finally blowing dry with hot air and using wire brush for the interface grinding, then combine the rear plate, middle plate and front plate, drill holes at the front and rear ends of the combined plate, and fix them with aluminum rivets to obtain the combined plate.

Apply heat treating to the combined plate at 450° C. for 1 h and then rolling the laminated aluminum alloy for the first time to obtain the thickness of 11 mm, wherein the hᵣₑₐᵣ+h_{middle} is about 4.9 mm;

Setting the 11 mm aluminum alloy weld-start plate and lead-out plate on the laminated aluminum alloy with a thickness of 11 mm, and then carrying out friction stir treatment, wherein the stirring needle is provided with a thread, the length of the stirring needle is 6 mm, the stirring tool rotates in from the side of the 7N01 aluminum alloy rear plate side, the back tilt angle of the stirring tool is 2°, the feed speed during the friction stir treatment is 250 mm/min and the stirring rotation speed is 800 r/min;

After the stirring treatment, the laminated aluminum alloy is heat-treated at 370° C. for 2 h and then rolled for the second time to obtain the laminated aluminum alloy with 8 mm thickness, and then the laminated aluminum alloy is solid solution treated at 480° C. for 1 h and aged at 120° C. for 36 h to obtain the laminated aluminum alloy with high interfacial bonding strength.

Contrast 1

The difference from Embodiment 1 is that, instead of friction stir treatment and second rolling treatment for the laminated aluminum alloy, the laminated aluminum alloy with 8 mm thickness is directly rolled after heating the combined plate for 2 h under 420° C., then the laminated aluminum alloy is subject to solid solution treatment under 470° C. for 2 h followed by 24h of aging treatment under 120° C., and other conditions are the same as those of Embodiment 1.

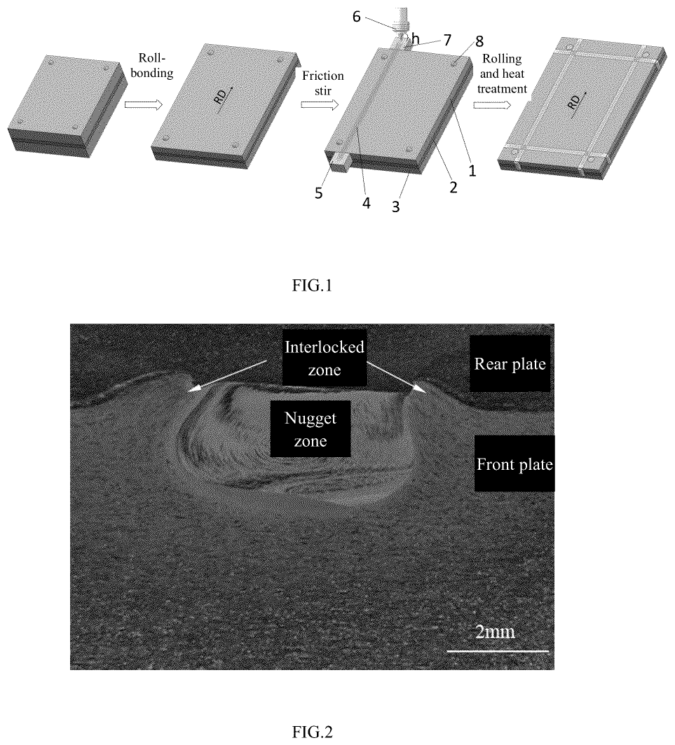

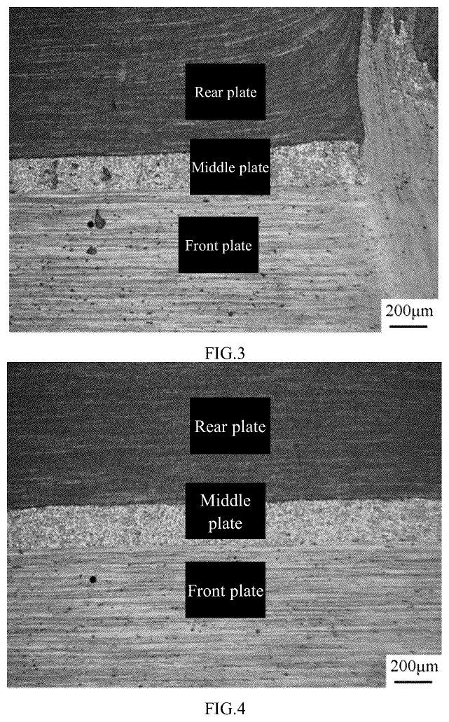

FIG. 2 and FIG. 3 show the microstructure diagrams of the laminated aluminum alloy prepared by Embodiment 1. From FIG. 2 and FIG. 3, it can be seen that the friction stir treatment has made the interlayer structure broken, a nugget zone is formed due to high temperature and plastic flowing produced by the friction stir; at the same time, since the interlayer interface has been bonded before the friction stir, hook-shaped and cold lap joint defects in friction stir lap welding will not be produced, resulting in few welding defects. The plastic flowing of materials on the vertical interface caused by friction stir forms an effective structure, that is, an interlocked zone, therefore a three-dimensional spatial structure consisting of the nugget zone and the interlocked zone is built. While FIG. 4 shows the shows typical layered structure. By comparison, it can be found that the laminated aluminum alloy prepared by the present invention breaks through the limitation that the interface of the traditional laminated aluminum alloy material is flat and prepares a laminated aluminum alloy with spatial structure. Since the strength of the materials in the interlocked zone and the nugget zone is much higher than that of the laminated aluminum alloy interface, therefore, the interfacial bonding strength of the laminated aluminum alloy is greatly improved. The interlayer shear strength of the laminated aluminum alloy is detected by the tension-shear experiments, and the interlayer shear strength of the Embodiment 1 is 195.2 MPa, and the interlayer shear strength of the Contrast 1 is 85.1 MPa.

As being revealed from the above embodiments, the present invention provides a high interfacial bonding strength laminated aluminum alloy manufacturing method, which firstly fixes the combination of rear plate, middle plate and front plate, then performs the first roll-boding treatment after heat treatment of the combined plate, then performs friction stir treatment on the obtained laminated aluminum alloy, and finally obtains the laminated aluminum alloy with high interfacial bond strength by heat treatment, second rolling treatment, solution treatment and aging treatment. The laminated aluminum alloy prepared by the present invention breaks through the limitation of traditional laminated aluminum alloy material interface being plane, and a laminated aluminum alloy with a spatial structure is prepared and the interlayer bonding strength is greatly improved.

The foregoing is only a preferred embodiment of the present invention. It should be pointed out that for those of ordinary skill in the art, several modifications and improvements can be made without departing from the principles of the present invention, and these modifications and improvements should also be considered as the scope of the present invention.

What is claimed is:

1. A high interfacial bonding strength laminated aluminum alloy manufacturing method, comprising the following steps:
(1) combining and fixing a rear plate, a middle plate, and a front plate to obtain a combined plate;
(2) performing a first heat treatment on the combined plate and then performing a first roll-bonding to obtain a laminated aluminum alloy;
(3) conducting a friction stir treatment after setting a weld-start plate and a lead-out plate on the laminated aluminum alloy; and
(4) carrying out a second heat treatment, a second rolling treatment, a solid solution treatment and an aging treatment in sequence on the laminated aluminum alloy after the friction stir treatment;
in the friction stir treatment in step (3), a stirring needle is provided with a thread, a length of the stirring needle is calculated by h=hᵣₑₐᵣ+h_{middle}+(0.1−10) mm, wherein, hᵣₑₐᵣ and h_{middle} are a thickness of the rear plate and a thickness of the middle plate after the first roll-bonding in step (2), respectively; during the friction stir treatment, a stirring tool rotates into the laminated aluminum alloy from a side of the rear plate, and a back tilt angle of the stirring tool is 1-3°; and a feed speed is 50-250 mm/min and a rotation speed is 400-2,500 r/min.

2. The high interfacial bonding strength laminated aluminum alloy manufacturing method according to claim 1, wherein
the rear plate in step (1) comprises 7N01 aluminum alloy or 7A52 aluminum alloy;
the middle plate comprises 1-series pure aluminum or 7A01 aluminum alloy; and
the front plate comprises 7055 aluminum alloy or 7A62 aluminum alloy.

3. The high interfacial bonding strength laminated aluminum alloy manufacturing method according to claim 2, wherein
in step (1), a first surface treatment is performed on the rear plate, the middle plate and the front plate before combination,
the surface treatment comprises:
alkaline washing with 5-15 wt % NaOH solution for 3-10 min,
rinsing with 80-100° C. water,
acid washing with 5-15 wt % HNO₃ solution for 3-10 min and then rinsing with 5-15° C. water, and
blow-drying and performing an interface polishing treatment in turn.

4. The high interfacial bonding strength laminated aluminum alloy manufacturing method according to claim 3, wherein in step (2), a temperature of the first heat treatment is 400-450° C., and a time of the first heat treatment is 1 to 3 h.

5. The high interfacial bonding strength laminated aluminum alloy manufacturing method according to claim 1, wherein the thickness of the laminated aluminum alloy in step (2) is 3 to 60 mm.

6. The high interfacial bonding strength laminated aluminum alloy manufacturing method according to claim 5, wherein in step (4) a temperature of the second heat treatment is 370 to 420° C. and a time of the second heat treatment is 1 to 2 h.

7. The high interfacial bonding strength laminated aluminum alloy manufacturing method according to claim 5, wherein in step (4) a temperature of the solid solution treatment is 450 to 490° C. and a time of the solid solution treatment is 1 to 3 h.

8. The high interfacial bonding strength laminated aluminum alloy manufacturing method according to claim 6, wherein in step (4) a temperature of the aging treatment is 100-150° C. and a time of the aging treatment is 12 to 48 h.

9. The high interfacial bonding strength laminated aluminum alloy manufacturing method according to claim 2, wherein the thickness of the laminated aluminum alloy in step (2) is 3 to 60 mm.

10. The high interfacial bonding strength laminated aluminum alloy manufacturing method according to claim 3, wherein the thickness of the laminated aluminum alloy in step (2) is 3 to 60 mm.

11. The high interfacial bonding strength laminated aluminum alloy manufacturing method according to claim 4, wherein the thickness of the laminated aluminum alloy in step (2) is 3 to 60 mm.
